(19) United States
(12) Patent Application Publication
(10) Pub. No.: US 2012/0275455 A1
(43) Pub. Date: Nov. 1, 2012

(54) METHOD AND APPARATUS FOR TRANSMITTING/RECEIVING BROADCAST SERVICE IN DIGITAL BROADCASTING SYSTEM, AND SYSTEM THEREOF

(75) Inventors: Sung-Oh HWANG, Yongin-si (KR); Jae-Yeon Song, Seoul (KR)

(73) Assignee: Samsung Electronics Co., Ltd., Suwon-si (KR)

(21) Appl. No.: 13/461,373

(22) Filed: May 1, 2012

(30) Foreign Application Priority Data
May 1, 2011 (KR) 10-2011-0041248
May 12, 2011 (KR) 10-2011-0044825

(51) Int. Cl. H04L 12/56

(52) U.S. Cl. 370/389

(57) ABSTRACT

Provided is a method for receiving a broadcast service in a digital broadcasting system. The method includes receiving a Service Guide Delivery Descriptor (SGDD) over a network, the SGDD providing signaling information related to reception of the broadcast service, extracting the signaling information from the received SGDD, and analyzing the extracted signaling information, receiving a service guide for reception of the broadcast service based on the analyzed signaling information, and receiving the broadcast service based on the received service guide.

PRIORITY

This application claims priority under 35 U.S.C. §119(a) to a Korean Patent Application filed in the Korean Intellectual Property Office on May 1, 2011 and assigned Serial No. 10-2011-0041248, and Korean Patent Application filed in the Korean Intellectual Property Office on May 13, 2011 and assigned Serial No. 10-2011-0044825, the contents of both of which are incorporated herein by reference.

### BACKGROUND OF THE INVENTION

1. Field of the Invention

The present invention relates generally to a method and apparatus for receiving broadcast services in a digital broadcasting system, and more particularly, to a method and apparatus for transmitting/receiving broadcast services based on signaling information for reception of broadcast services in a digital broadcasting system.

2. Description of the Related Art

Due to the development of communication and broadcasting technologies, Mobile Broadcast Service, which provides broadcast services to mobile terminals in the conventional broadcasting system and/or mobile communication system, has evolved since the mid-2000s due to its full-fledged standardization and commercialization. As a result, 2^{nd} generation mobile broadcast standards were disclosed, such as Next Generation Handheld (NGH), which was established by Digital Video Broadcasting (DVB), a European digital broadcast standard organization. NGH includes a Moving Picture Experts Group 2 (MPEG2) Transport Stream (TS) profile for thriving on the terrestrial broadcasting network, and an Internet Protocol (IP) profile for linkage with an IP.

The MPEG2 TS profile provides service information and information about the network to which the service is transferred, based on Program Specific Information/Service Information (PSI/SI) provided by TS. For this, however, the IP profile uses a separate method, because it does not use MPEG2 TS. As such, there is a need in the art for a scheme capable of efficiently providing signaling information of a DVB-NGH IP profile.

### SUMMARY OF THE INVENTION

An aspect of the present invention is to provide a method and apparatus for efficiently transmitting/receiving broadcast services based on signaling information in a digital broadcasting system, and a system thereof

Another aspect of the present invention is to provide a method and apparatus for efficiently transmitting/receiving signaling information for reception of broadcast services in a digital broadcasting system.

Another aspect of the present invention is to provide a method and apparatus for transmitting/receiving signaling information for reception of broadcast services using a Service Guide Delivery Descriptor (SGDD) in a digital broadcasting system.

Another aspect of the present invention is to provide a method and apparatus for efficiently transmitting/receiving signaling information for reception of information existing in a lower layer of an IP layer in a DVB-NGH IP profile.

In accordance with one aspect of the present invention, there is provided a method for receiving a broadcast service in a digital broadcasting system. The method includes receiving an SGDD over a network, the SGDD providing signaling information related to reception of the broadcast service, extracting the signaling information from the received SGDD, and analyzing the extracted signaling information, receiving a service guide for reception of the broadcast service based on the analyzed signaling information, and receiving the broadcast service based on the received service guide.

In accordance with another aspect of the present invention, there is provided an apparatus for receiving a broadcast service in a digital broadcasting system. The apparatus includes a receiver for receiving, over a network, the broadcast service and signaling information related to reception of the broadcast service, and a controller for receiving an SGDD providing the signaling information, extracting the signaling information from the received SGDD, analyzing the extracted signaling information, receiving a service guide for reception of the broadcast service based on the analyzed signaling information, and receiving the broadcast service based on the received service guide.

In accordance with further another aspect of the present invention, there is provided a method for providing a broadcast service in a digital broadcasting system. The method includes transmitting an SGDD over a network, the SGDD including signaling information related to the broadcast service, transmitting a service guide for reception of the broadcast service that a terminal may receive based on the signaling information, and transmitting the broadcast service related to the service guide.

In accordance with yet another aspect of the present invention, there is provided a system for providing a broadcast service in a digital broadcasting system. The system includes means for providing an SGDD over a network, the SGDD including signaling information related to the broadcast service, means for providing a service guide for reception of the broadcast service that a terminal may receive based on the signaling information, and means for providing the broadcast service related to the service guide.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 illustrates a structure of an Open Mobile Alliance Mobile Broadcast (OMA BCAST) service guide;

FIG. 2 illustrates a structure of upper layer signaling in DVB-NGH;

FIG. 3 illustrates a structure of a transmission device for generating and transmitting an SGDD disclosed in an embodiment of the present invention;

FIG. 4 illustrates a structure of a reception device for receiving an SGDD disclosed in an embodiment of the present invention;

FIG. 5 illustrates a process of generating signaling information in the transmission device of FIG. 3; and

FIG. 6 illustrates a process of receiving signaling information in the reception device of FIG. 4.

Throughout the drawings, the same drawing reference numerals will be understood to refer to the same elements, features and structures.

### DETAILED DESCRIPTION OF EMBODIMENTS OF THE INVENTION

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

Although DVB-NGH, and Open Mobile Alliance Browser and Content Mobile Broadcast (OMA BAC BCAST) technology (or a mobile broadcast standard), among the broadcasting technologies to which the present invention is applicable, will be considered in the following description, it is not intended to limit the scope and spirit of the invention.

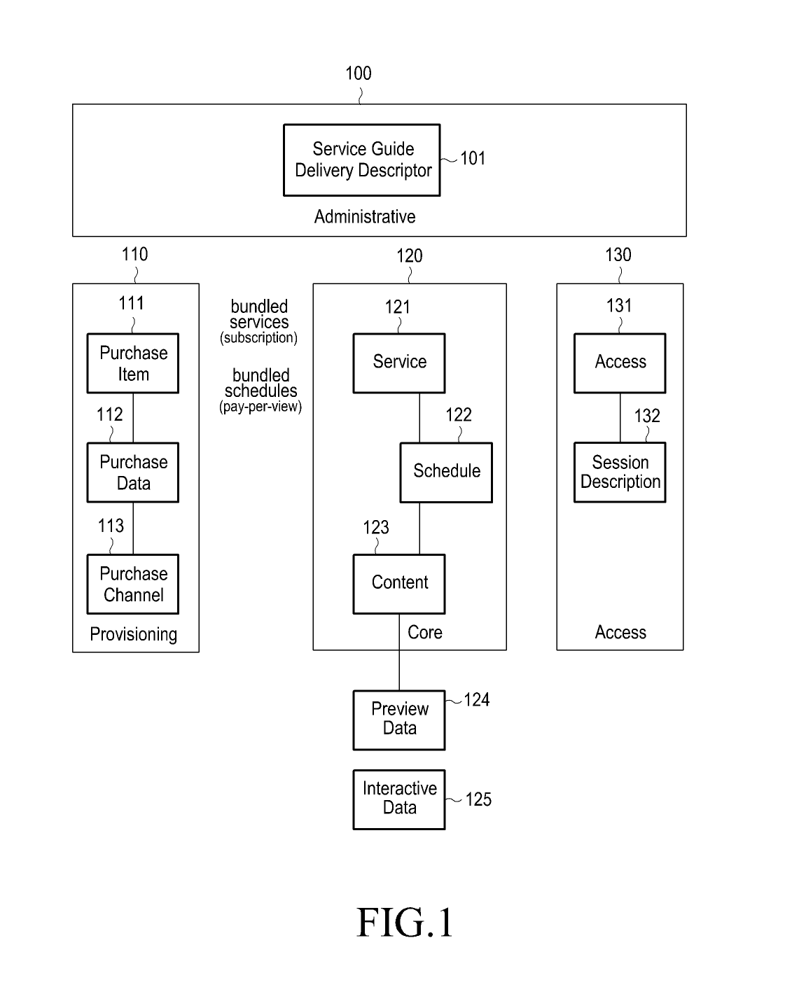

FIG. 1 illustrates a conventional structure of a service guide disclosed for mobile broadcasting in OMA BCAST Working Group to which the present invention is applied.

As illustrated in FIG. 1, one service guide includes a plurality of fragments having individual purposes, wherein the fragments are divided into four major groups according to their usages.

Referring to FIG. 1, a service guide includes an administrative group 100, a provisioning group 110, a core group 120, and an access group 130.

The administrative group 100 provides basic information based on which service guide may be received. The administrative group 100 includes a Service Guide Delivery Descriptor (SGDD) 101, which provides information about a channel over which a plurality of service guide fragments may be received, schedule information, and update information, to a terminal so that the terminal may receive only the necessary service guide at an appropriate time.

The provisioning group 110 provides fee information for reception of a service, and includes a purchase item fragment 111, a purchase data fragment 112, and a purchase channel fragment 113. The purchase item fragment 111 provides fee information for services or bundled services, and the purchase data fragment 112 provides information indicating a method in which the service user may pay for the service. The purchase channel fragment 113 provides information about a system from which the service user may purchase the service.

The core group 120 provides information about the service, and includes a service fragment 121, a schedule fragment 122, and a content fragment 123. The service fragment 121 provides a description of the service that the user will receive, and information indicating the content constituting the service that the user will receive. The schedule fragment 122 provides information about the time in which the service may be provided. The content fragment 123 provides information about a plurality of contents constituting the service.

The access group 130 includes an access fragment 131 and a session description fragment 132. The access group 130 provides service access information indicating the manner in which the terminal may receive the service in the core group 120, and detailed information about the session on which contents constituting the service may be delivered, to the terminal so that the terminal may access the service. The access fragment 131 provides a plurality of access methods to one service to the terminal, thereby providing a method in which the terminal may access a variety of value-added services based on one service. The session description fragment 132 provides session information for the service, defined in one access fragment and transmitted by the service access.

Referring to FIG. 1, the service guide includes a preview data fragment 124 and an interactive data fragment 125 in addition to the four groups. The preview data fragment 124 provides a preview and icons of a service and content, and the interactive data fragment 125 serves to provide information about an interactive service in which the user may participate while enjoying the broadcast service.

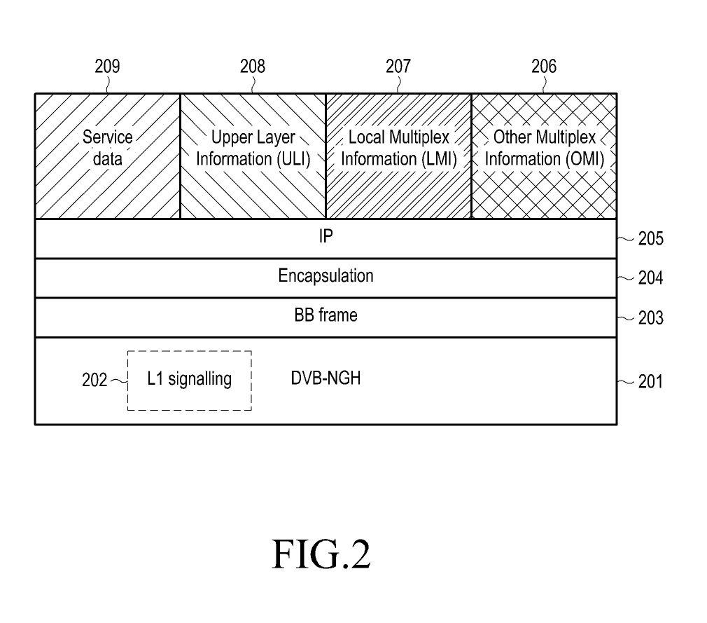

FIG. 2 illustrates an example of an NGH protocol defined by DVB-NGH, to which the present invention is applied. A structure of upper layer signaling in DVB-NGH will be described with reference to FIG. 2.

Referring to FIG. 2, DVB-NGH 201, an NGH physical layer is for transporting a bitstream using a proper modulation scheme. The DVB-NGH 201 conveys Layer-1 (L1) signaling information 202, which includes information needed in a physical layer, such as information based on which a terminal may find a DVB-NGH network. A BaseBand (BB) frame 203 is used in an upper layer of the physical layer. Data delivered from an upper layer is formed into the BB frame 203 after undergoing framing in an encapsulating layer 204. Reference numeral 205 represents an Internet Protocol (IP) layer, and in FIG. 2, signaling information such as service data 209, Upper Layer Information (ULI) 208, Local Multiplex Information (LMI) 207 and Other Multiplex Information (OMI) 206 is transported in an upper layer of the IP layer 205.

The signaling information such as OMI 206, LMI 207, and ULI 208 is used to receive information existing in a lower layer(s) of the IP layer 205.

The OMI 206 is for providing network identification information and frequency information of a DVB-NGH system where the service data 209 is transmitted. The LMI 207 is for providing link information to NGH Logical Link Pipe (LLP) and NGH Physical Link Pipe (PLP), and buffer model information of the LLP. The ULI 208 is for providing service-related information such as a BCAST service guide, and link information such as LLP and PLP in which the service is transferred.

In an embodiment of the present invention, in terms of information configuration, service connection information of the OMI 206, LMI 207 and ULI 208 may be similar to or different from the information carried by PSI/SI of MPEG2 TS in the existing MPEG2 broadcasting system.

The signaling information of OMI 206, LMI 207 and ULI 208 includes information related to service connection, and is transferred in the upper layer of the IP layer 205. The signaling information is used to receive information (e.g., Layer 2 (L2) signaling) existing in the lower layer of the IP layer 205. Although the information existing in the lower layer of the IP layer 205 is assumed to be L2 signaling information in an embodiment of the present invention, the information is not necessarily limited to the L2 signaling information.

Therefore, in accordance with the NGH protocol in FIG. 2, the signaling information needed to receive information existing in the lower layer of the IP layer 205 should be transferred in the upper layer of the IP layer 205, and a detailed scheme therefore is required.

As such, the present invention provides a scheme of transmitting signaling information including at least one of the OMI, LMI and ULI in the upper layer of the IP layer using the SGDD, and its detailed example will be now described.

In the following tables, in “Type”, “E” indicates an element, “A” indicates an attribute, and a number following “E” indicates a hierarchy. For example, in the following tables, if E6 exists under an element E5, the E6 belongs to the element E5. In addition, “Category” indicates whether the element should be supported Mandatorily (M) or Optionally (O) in the Network N and the Terminal T. “Cardinality” indicates the number of elements that can be transmitted. For example, Cardinality=“1” indicates that one element may be transmitted, and Cardinality=“0 . . . N” indicates that 0 to N elements may be transmitted.

Tables 1 to 9 below describe a structure of an SGDD disclosed to transmit signaling information existing in an upper layer of the IP layer, which is needed to receive information existing in a lower layer of the IP layer in an NGH IP profile in an embodiment of the present invention. Although the following Tables 1 to 9 are divided for convenience of description, they are separated from a single table.

TABLE 1

| | | | | | Data |
|---|---|---|---|---|---|
| Name | Type | Category | Cardinality | Description | Type |
| ServiceGuideDeliveryDescriptor | E | | | The Service Guide Delivery Descriptor | |
| | | | | Contains the following attributes: | |
| | | | | id | |
| | | | | version | |
| | | | | Contains the following elements: | |
| | | | | NotificationReception | |
| | | | | BSMList | |
| | | | | DescriptorEntry | |
| | | | | TerminalCapability | |
| | | | | SGEntryPoints | |
| | | | | RMS | |
| | | | | AudienceMeasurement | |
| | | | | PrivateExt | |
| id | A | NM/TM | 0 . . . 1 | Unique identifier of the SGDD within one | anyURI |
| | | | | specific SG | |
| | | | | This attribute SHALL be instantiated if the | |
| | | | | SGDD is delivered over broadcast channel | |
| version | A | NM/TM | 0 . . . 1 | Version of SGDD. The newer version overrides | unsigned |
| | | | | the older one as soon as it has been received. | Int |
| | | | | This attribute SHALL be instantiated if the | |
| | | | | SGDD is delivered over broadcast channel | |
| Notification | E1 | NO/TO | 0 . . . 1 | Reception information for general Notification | |
| Reception | | | | Messages. | |
| | | | | In case of delivery over Broadcast channel, | |
| | | | | IPBroadcastDelivery specifies the address | |
| | | | | information for receiving Notification message. | |
| | | | | In case of delivery over Interaction channel, | |
| | | | | PollURL specify address information for polling | |
| | | | | notification and ‘PollPeriod’ specifies the | |
| | | | | associated polling period. | |
| | | | | When the Notification Message resource pointed | |
| | | | | by this element provides Notification Messages | |
| | | | | carrying Service Guide update, those SHALL | |
| | | | | relate to the currently bootstrapped Service | |
| | | | | Guide. | |
| | | | | If this element is present, at least one of the | |
| | | | | elements “IPBroadcastDelivery”, or “PollURL” | |
| | | | | SHALL be present. | |
| | | | | This element SHALL be supported by the | |
| | | | | Network in case it supports the Notification | |
| | | | | function. Similarly, this element SHALL be | |
| | | | | supported by the Terminal in case it supports the | |
| | | | | Notification function. | |
| | | | | Contains the following elements: | |
| | | | | IPBroadcastDelivery | |
| | | | | PollURL | |
| | | | | PollPeriod | |

TABLE 2

| | | | | |
|---|---|---|---|---|
| BSMList | E1 | NM/TM | 0 . . . 1 | Declaration of the BSM Selectors which can be |
| | | | | used in the GroupingCriteria sections defined |
| | | | | below. |
| | | | | Contains the following element: |
| | | | | BSMSelector |
| DescriptorEntry | E1 | NM/ | 0 . . . N | An entry in the Service Guide Delivery |
| | | TM | | Descriptor. |
| | | | | Contains the following attribute: |
| | | | | type |
| | | | | Contains the following elements: |
| | | | | GroupingCriteria, |
| | | | | Transport, |
| | | | | AlternativeAccessURL, |
| | | | | ServiceGuideDeliveryUnit |
| | | | | Note: A ‘simplified’ SGDD without any |
| | | | | DescriptorEntry is only possible as a response |
| | | | | result to a terminal request for a “simplified” |
| | | | | SGDD (see section 5.4.4.3). |
| TerminalCapability | E1 | NO/TM | 0 . . . N | Specifies the required terminal capabilities |
| | | | | associated with the fragments in this Service |
| | | | | Guide Delivery Unit |
| | | | | This element provides the information to the |
| | | | | terminal what is needed to consume the services |
| | | | | declared by the SGDU's in this SGDD |
| | | | | DescriptorEntry - among the SGDU's that are |
| | | | | announced in various DescriptorEntries in various |
| | | | | SGDD's. |
| | | | | Based on this information the terminal can |
| | | | | process the service guide fragments in |
| | | | | dependence of the terminal capabilities. If the |
| | | | | terminal can find a single match among the |
| | | | | various distribution types under |
| | | | | BroadcastServiceDeliveryType or |
| | | | | UnicastServiceDeliveryType the terminal can |
| | | | | decide to process the service guide fragments. In |
| | | | | case the terminal cannot meet any of the specified |
| | | | | capabilities requirements, the terminals can |
| | | | | decide to acquire the service guide fragments |
| | | | | declared by the SGDU's in this SGDD and just |
| | | | | store them, or it can choose not to acquire them at |
| | | | | all. In any case the terminal SHOULD NOT |
| | | | | render the fragments associated with the service |
| | | | | to the user, for which it cannot meet any of the |
| | | | | specified terminal capability requirements. It has |
| | | | | to be noted that terminal capabilities are not |
| | | | | dependent on the local network coverage aspects, |
| | | | | i.e. a terminal MAY decide to render the |
| | | | | fragments associated to a given broadcast (resp. |
| | | | | unicast) delivery system for which it is |
| | | | | temporarily out of radio coverage. |
| | | | | Contains the following elements: |
| | | | | BroadcastServiceDeliveryType |
| | | | | UnicastServiceDeliveryType |

TABLE 3

| | | | | |
|---|---|---|---|---|
| SGEntryPoints | E1 | NO/TM | 0 . . . N | Each SGEntryPoints element declares entry |
| | | | | points which are associated with one BSM |
| | | | | selector or independent from any BSM selector. |
| | | | | The SGDDs that are signalled in a given FLUTE |
| | | | | FDT instance from a SG Announcement Channel |
| | | | | SHALL contain the same set of SGEntryPoints |
| | | | | elements. |
| | | | | In the same SGDD, at most once SGEntryPoints |
| | | | | element including a given BSMselector SHALL |
| | | | | be instantiated |
| | | | | In the same SGDD, at most once SGEntryPoints |
| | | | | element including no BSMselector SHALL be |
| | | | | instantiated |
| | | | | This element SHALL not be instantiated in a |
| | | | | response of a terminal request over the interaction |
| | | | | channel, if the key “SGEntryPointsOnly” (see |
| | | | | section 5.4.3.3) is not present in the request. |
| | | | | Contains the following attribute: |
| | | | | id |
| | | | | Contains the following elements: |
| | | | | BSMSelector |
| | | | | SGEntryPoint |
| | | | | Note that the support of the SGEntryPoints |
| | | | | element is not mandated for non connected |
| | | | | terminals |

TABLE 4

| | | | | | |
|---|---|---|---|---|---|
| id | A | NM/TM | 0 . . . 1 | Identifies this particular “SGEntryPoints” | unsigned |
| | | | | element. This attribute is scoped by the | Int |
| | | | | announcement channel (resp. interactive bootstrap | |
| | | | | URL) from which the “SGEntryPoints” element is | |
| | | | | fetched. A given SGEntryPoints SHALL have a | |
| | | | | different id when it has been updated and SHALL | |
| | | | | not reuse the same id, except for “id” wrap- | |
| | | | | around case. | |
| BSMSelector | E2 | NM/ | 0 . . . 1 | Specifies the BSM associated with the entry point | |
| | | TM | | by referencing a BSMSelector structure declared | |
| | | | | above. | |
| | | | | Note that if this element is not instantiated, then | |
| | | | | any terminal that fetches this given SGDD | |
| | | | | SHALL consider that the related SGEntryPoint | |
| | | | | applies to its affiliated BSM. | |
| | | | | Contains the following attribute: | |
| | | | | idRef | |
| idRef | A | NM/TM | 1 | Reference to the identifier of the BSMSelector | anyURI |
| | | | | declared within the ‘BSMList’ above. | |
| SGEntryPoint | E2 | NM/TM | 1 . . . N | This element gives the SG entry points that relate | |
| | | | | to a given BSM over interaction and/or broadcast | |
| | | | | channels. | |
| | | | | Contains the following elements: | |
| | | | | BroadcastServerSession | |
| | | | | UnicastServerURL | |
| | | | | For each declared SGEntryPoint, | |
| | | | | BroadcastServerSession and/or | |
| | | | | UnicastServerURL(s) can be instantiated. When | |
| | | | | both are instantiated in a given SGEntryPoint, the | |
| | | | | list of UnicastServerURLs is the set of SG entry | |
| | | | | points over the interaction channel that are | |
| | | | | associated to the declared Broadcast Entry Point, | |
| | | | | bearing different possible relationships (see the | |
| | | | | attribute relationOfICWithBC of | |
| | | | | UnicastServerURL for more details). The | |
| | | | | terminal can select among the available and | |
| | | | | applicable entry points. The selection process | |
| | | | | (e.g., can depend on factors such as user or | |
| | | | | service provider preference) is out-of-scope of the | |
| | | | | current specification. | |

TABLE 5

| | | | | | |
|---|---|---|---|---|---|
| BroadcastServerSession | E3 | NM/TM | 0 . . . 1 | This element gives the SG entry point over | |
| | | | | broadcast channel. | |
| | | | | “BroadcastServerSession” SHALL not be | |
| | | | | instantiated when it is intended to refer to the | |
| | | | | actual entry point (i.e. Announcement Channel) | |
| | | | | over which the current SGDD has been delivered. | |
| | | | | When the declared unicast entry point(s) are | |
| | | | | independent from any broadcast entry point, i.e., | |
| | | | | the “relationOfICWithBC” attribute of | |
| | | | | UnicastServerURL is set to value “0”, | |
| | | | | “BroadcastServerSession” SHALL not be | |
| | | | | instantiated either. | |
| | | | | Contains the following attributes: | |
| | | | | ipAddress | |
| | | | | port | |
| | | | | srcIpAddress | |
| | | | | transmissionSessionID | |
| | | | | contains the following element: | |
| | | | | BDSType | |
| ipAddress | A | NM/ | 1 | Destination IP address of the target delivery | string |
| | | TM | | session | |
| port | A | NM/ | 1 | Destination port of target delivery session | unsigned |
| | | TM | | | Short |
| srcIpAddress | A | NM/ | 0 . . . 1 | Source IP address of the delivery session | string |
| | | TM | | In case source specific multicast scheme is | |
| | | | | applied in the transmission, then the | |
| | | | | ‘srcIpAddress’ attribute SHALL have as its value | |
| | | | | the IP address found in the IP-packets belonging | |
| | | | | to the IP-stream in question. | |
| | | | | In case this attribute is omitted, there SHALL | |
| | | | | only be one source IP address from which the file | |
| | | | | delivery session originates which is defined by | |
| | | | | the combination of destination IP address, port | |
| | | | | and transmission session ID given. | |
| transmission | A | NM/ | 1 | This is the Transmission Session Identifier (TSI) | unsigned |
| SessionID | | TM | | of the FLUTE session | Short |

TABLE 6

| | | | | | |
|---|---|---|---|---|---|
| BDSType | E4 | NM/ | 1 | Information about the underlying broadcast | complex |
| | | TM | | distribution system for SG delivery | Type |
| | | | | Contains the following attributes: | |
| | | | | type | |
| | | | | version | |
| | | | | Contains the following element: | |
| | | | | BDSSpecificEntryPointInfo | |
| type | A | NM/TM | 1 | Type of underlying broadcast distribution system | unsigned |
| | | | | for SG delivery, possible values: | Byte |
| | | | | 0. IPDC over DVB-H | |
| | | | | 1. 3GPP MBMS | |
| | | | | 2. 3GPP2 BCMCS | |
| | | | | 3. DVB-SH | |
| | | | | 4. WiMax | |
| | | | | 5. FLO | |
| | | | | 6. DVB0NGH | |
| | | | | 7-127. reserved for future use | |
| | | | | 128-255. reserved for proprietary use | |
| version | A | NM/ | 0 . . . 1 | Version of underlying broadcast distribution | string |
| | | TO | | system. Possible values for MBMS are specified | |
| | | | | according to the following syntax in ABNF | |
| | | | | [RFC4234]: | |
| | | | | version = “3GPP.” release “.” bearer | |
| | | | | release = “R6” / “R7” / “R8” | |
| | | | | bearer = “GERAN” / “UTRAN” / | |
| | | | | “MBSFN-FDD” / “ MBSFN-TDD” / | |
| | | | | “MBSFN-IMB” | |
| | | | | By applying these rules, strings such as | |
| | | | | 3GPP.R6.UTRAN and 3GPP.R8.MBSFN-IMB | |
| | | | | can be constructed. To allow backwards | |
| | | | | compatibility with BCAST 1.0, the | |
| | | | | strings “Rel-6” and “Rel-7” (which do not | |
| | | | | follow the ABNF syntax above) are also | |
| | | | | included in the set of possible values for | |
| | | | | MBMS. | |
| | | | | Other possible values include, e.g., 1x or | |
| | | | | HRPD or Enhanced HRPD for BCMCS. When | |
| | | | | this attribute is omitted, it means that it | |
| | | | | applies to all versions. | |
| | | | | A terminal supporting the BDS signaled by | |
| | | | | “type” attribute SHALL support this attribute | |
| | | | | when present, and SHALL ignore it otherwise. | |

TABLE 7

| | | | | | |
|---|---|---|---|---|---|
| BDSSpecific | E5 | NM/TO | 0 . . . 1 | The placeholder for the supplementary | Abstract |
| EntryPointInfo | | | | information that is required in order to retrieve the | complex |
| | | | | broadcast SG entry point in a given BDS (for | Type |
| | | | | example, platform_id for DVB-H). The use of | “BDSSpecific |
| | | | | this placeholder is described in BDS adaptation | EntryPoint |
| | | | | specifications | InfoType” |
| | | | | A terminal supporting the BDS signaled by | derived by |
| | | | | “type” attribute SHALL support this element | extension |
| | | | | (whatever the substituted type signalled by | in respective |
| | | | | ‘xsi:types’ is), and SHALL ignore it otherwise. | BDS |
| | | | | When DVB-NGH is BDS, it contains the | Adaptation |
| | | | | following elements | TSs. |
| | | | | UpperLayerInformation | |
| | | | | LocalMultiplexInformation | |
| | | | | OtherMultiplexInformation | |
| UpperLayer | E6 | NO/TO | 0 . . . n | This elements provides the service/component | |
| Information | | | | mapping information with NGH signalling. | |
| | | | | It has the following attributes. | |
| Version | | NO/TO | 0 . . . 1 | It indicates the version of UpperLayerInformation | |
| Repetition | A | NO/TO | 0 . . . 1 | In indicates the repetition period of ULI. With | |
| Period | | | | these value terminal does not need to receive | |
| | | | | SGDD everytime. | |
| LocalMultiplex | E6 | NO/TO | 0 . . . n | This elements provides the information of Local | |
| Information | | | | Multiplexing in NGH network | |
| Version | A | NO/TO | 0 . . . 1 | It indicates the version of | |
| | | | | LocalMultiplexInformation | |
| Repetition | A | NO/TO | 0 . . . 1 | In indicates the repetition period of ULI. With | |
| Period | | | | these value terminal does not need to receive | |
| | | | | SGDD everytime. | |
| OtherMultiplex | E6 | NO/TO | 0 . . . n | This elements provides the information of NGH | |
| Information | | | | network ID, Frequency and so on. | |
| Version | A | NO/TO | 0 . . . 1 | It indicates the version of | |
| | | | | OtherMultiplexInformation | |
| Repetition | A | NO/TO | 0 . . . 1 | In indicates the repetition period of ULI. With | |
| Period | | | | these value terminal does not need to receive | |
| | | | | SGDD everytime. | |

TABLE 8

| | | | | |
|---|---|---|---|---|
| UnicastServerURL | E3 | NM/TM | 0 . . . N | This element gives the information regarding the |
| | | | | SG entry point over the interaction channel. If |
| | | | | there are multiple declared URLs, terminals will |
| | | | | choose the appropriate one according to the |
| | | | | purpose of accessing SG over the interaction |
| | | | | channel. |
| | | | | Contains the following attributes: |
| | | | | relationOfICwithBC |
| | | | | url |
| | | | | contains the following element: |
| | | | | UnicastType |
| RMS | E1 | NO/TO | 0 . . . N | Signals the existence of Rich Media Solution |
| | | | | template documents for the presentation of SG. If |
| | | | | the terminal has delays in rendering the Rich |
| | | | | Media Solution template, it may render the SG |
| | | | | using its native rendering engine during the |
| | | | | meantime. |
| | | | | Contains the following elements: |
| | | | | BSMSelector |
| | | | | RMSTemplate |
| AudienceMeasurement | E1 | NO/TO | 0 . . . 1 | Signals the Audience Measurement function |
| | | | | Contains the following elements: |
| | | | | CampaignInfo |
| | | | | AudienceMeasurementTrigger |

TABLE 9

| | | | | |
|---|---|---|---|---|
| PrivateExt | E1 | NO/ | 0 . . . 1 | An element serving as a container for proprietary |
| | | TO | | or application-specific extensions. |
| | | | | It has the following element |
| | | | | NGH_Signaling |
| NGH_Signaling | E2 | NO/TO | 0 . . . n | When DVB-NGH is BDS, it contains the |
| | | | | following elements |
| | | | | UpperLayerInformation |
| | | | | LocalMultiplexInformation |
| | | | | OtherMultiplexInformation |
| UpperLayerInformation | E3 | NO/TO | 0 . . . n | This elements provides the service/component |
| | | | | mapping information with NGH signalling. |
| | | | | It has the following attributes. |
| Version | A | NO/TO | 0 . . . 1 | It indicates the version of UpperLayerInformation |
| Repetition | A | NO/TO | 0 . . . 1 | In indicates the repetition period of ULI. With |
| Period | | | | these value terminal does not need to receive |
| | | | | SGDD everytime. |
| LocalMultiplexInformation | E3 | NO/TO | 0 . . . n | This elements provides the information of Local |
| | | | | Multiplexing in NGH network |
| Version | A | NO/TO | 0 . . . 1 | It indicates the version of |
| | | | | LocalMultiplexInformation |
| Repetition | A | NO/TO | 0 . . . 1 | In indicates the repetition period of ULI. With |
| Period | | | | these value terminal does not need to receive |
| | | | | SGDD everytime. |
| OtherMultiplexInformation | E3 | NO/TO | 0 . . . n | This elements provides the information of NGH |
| | | | | network ID, Frequency and so on. |
| Version | A | NO/TO | 0 . . . 1 | It indicates the version of |
| | | | | OtherMultiplexInformation |
| Repetition | A | NO/TO | 0 . . . 1 | In indicates the repetition period of ULI. With |
| Period | | | | these value terminal does not need to receive |
| | | | | SGDD everytime. |
| UpperLayerInformation | E3 | NO/TO | 0 . . . n | This elements provides the service/component |
| | | | | mapping information with NGH signaling |
| <proprietary | E2 | NO/TO | 0 . . . N | Proprietary or application-specific elements that |
| elements> | | | | are not defined in this specification. These |
| | | | | elements may further contain sub-elements or |
| | | | | attributes. |

In a description of the SGDD in Tables 1 to 9, details unrelated to the present invention are omitted, and known elements other than the elements in the SGDD are disclosed in detail in OMA BCAST Service Guide 1.1. The SGDD includes ‘NotificationReception’ providing information for reception of a notification message for an event, ‘BSMlist’ providing information about the service provider and roaming operator from which the service is presently received, ‘DescriptionEntry’ having information about all service guide fragments transmitted over the current network, ‘TerminalCapability’ providing terminal's requirement information needed for reception of an any service, ‘SGEntrypoint’ providing information needed for reception of a service guide in each mobile broadcast transmission system, ‘RMS’ providing information about Reach Media Service (RMS) such as MPEG Laser, ‘AudienceMeasurement’ enabling measurement of usage of mobile broadcast services, and ‘PrivateExtension’ enabling a service provider to deliver the SGDD to transmit data.

A first embodiment of the present invention, which transmits signaling information used to receive information (e.g., L2 signaling) existing in a lower layer of the IP layer using the SGDD, provides the ULI, LMI and OMI using “BDSSpecificEntrypointInfo” in Table 7, which is a lower element of the ‘SGEntrypoint’.

The ‘BDSSpecificEntrypointInfo’ is an element of the SGDD for providing information based on which the terminal may smoothly receive the service guide according to the characteristics of a digital broadcasting system such as Internet Protocol Data Casting (IPDC) over DVB-H, 3GPP Multimedia Broadcast Multicast Service (MBMS), 3GPP2 Broadcast/Multicast Service (BCMCS), DVB-SH, WiMAX MCBCS, and Forward Link Only (FLO) supported by OMA BCAST. As described above, the first embodiment of the present invention provides signaling information of at least one of the ULI, LMI and OMI using “BDSSpecificEntrypointInfo” in Table 7, for reception of NGH.

An “UpperLayerInformation” element in Table 7 provides ULI signaling information and includes ‘ULI version’ and ‘ULI repetition period’ as its lower attributes. ‘ULI version’, a value indicating a version of ULI presently provided using the SGDD, allows the terminal to receive new ULI upon discovering URL with a version higher (or newer) than a version value of the presently stored ULI. The ‘ULI repetition period’ announces a transmission time of the next ULI, thereby preventing the terminal from unnecessarily receiving the SGDD for ULI acquisition continuously.

A “LocalMultiplexInformation” element in Table 7 provides LMI signaling information, and includes LMI version and LMI repetition period as its lower attributes. ‘LMI version’ and ‘LMI repetition period’ operate the same as ‘ULI version’ and ‘ULI repetition period’.

An “OtherMultiplexInformation” element in Table 7 provides OMI signaling information, and includes ‘OMI version’ and ‘OMI repetition period’ as its lower attributes. ‘OMI version’ and ‘OMI repetition period’ operate the same as ‘ULI version’ and ‘ULI repetition period’.

A second embodiment of the present invention, which transmits signaling information used to receive information (e.g., L2 signaling) existing in a lower layer of the IP layer using the SGDD, provides the ULI, LMI and OMI using a “PrivateExt” field of the SGDD illustrated in Table 9.

The “PrivateExt” field is for providing additional data if required by the service provider, and its details may vary depending on the service providers. A service provider providing a mobile broadcast service using NGH may provide at least one of the ULI, LMI and OMI using the ‘PrivateExt’ field of the SGDD, and may transmit the same information as that of the ‘UpperLayerInformation’ element, ‘LocalMultiplexInformation’ element and ‘OtherMultiplexInformation’ element described in the first embodiment, using the ‘PrivateExt’ field.

Transmitting the ULI, LMI and OMI using the SGDD in Tables 1 to 9 has the following two advantages.

First, BCAST SG carries a variety of fragments as shown in FIG. 1. Advantageously, BCAST SG may show all of the mobile broadcast services by a specific service provider or may show mobile broadcast services in a specific genre, through a combination of the fragments. SGDD serves to provide configuration information of the service guide made through a combination of the fragments. The SGDD is frequently transmitted on a repetitive basis, as the terminal should first receive the SGDD for reception of the service provided by BCAST. Therefore, in an embodiment of the present invention, the SGDD allows an NGH terminal to quickly obtain ULI, LMI and OMI.

Second, a specific protocol is required to transmit ULI, LMI and OMI in an upper layer of the IP layer as shown in FIG. 2. In this case, the existing IP-family protocol should be modified, or a new protocol should be made. If BCAST SG is used, implementation of the terminal is reduced, because the terminal receives ULI, LMI and OMI using the conventional protocol.

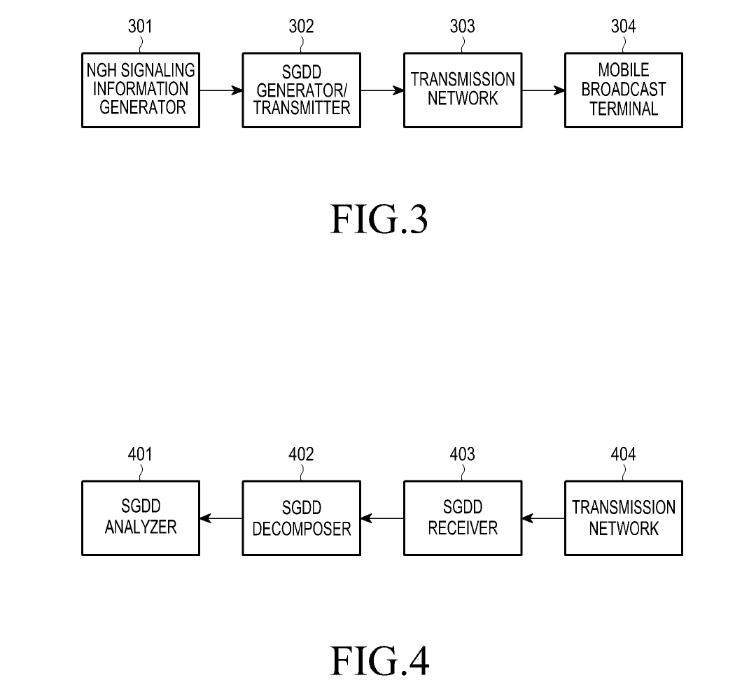

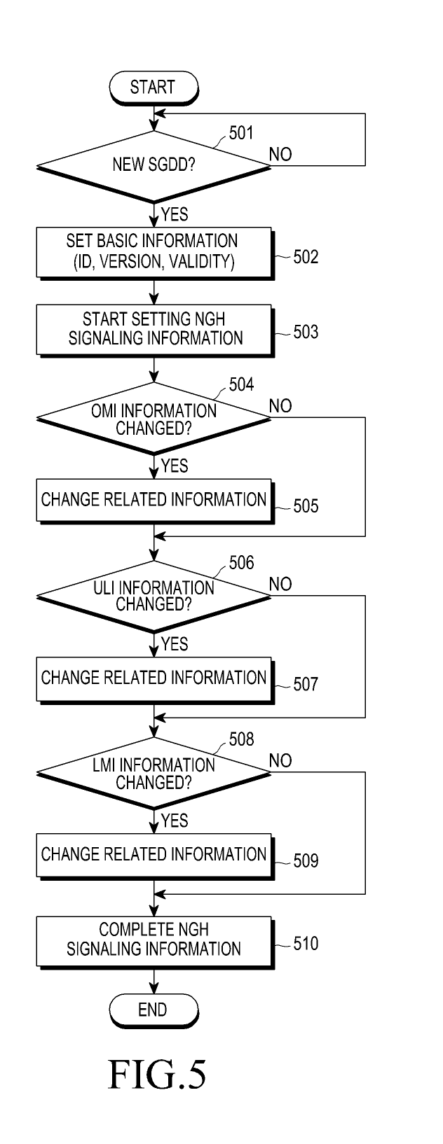

FIG. 3 illustrates configuration of a system including a transmission device for generating an SGDD with signaling information and transmitting the SGDD to a terminal according to a first or second embodiment of the present invention. FIG. 5 illustrates a process of generating the signaling information in the transmission device of FIG. 3.

Referring to FIG. 3, an NGH signaling information generator 301 generates signaling information needed for ULI, LMI and OMI in an SGDD with the structure illustrated in Table 7 or Table 9.

A process of generating the signaling information will be described with reference to FIG. 5. The transmission device determines in step 501 whether a new SGDD is needed. If a new SGDD is needed, the transmission device sets basic information such as identifier, version, and validity of an SGDD in step 502. In step 503, the transmission device starts generating NGH signaling information as the signaling information. In step 504, the transmission device determines whether OMI-related information (e.g., information such as network identifier and NGH frequency) is changed. If the OMI information is changed, the transmission device changes related information in step 505. Otherwise, the transmission device proceeds to step 506 without the change in OMI information.

The transmission device determines in step 506 whether there is a change in ULI information. If there is a change in ULI information, it indicates a change in information corresponding to the service and the PLP or LLP. If the ULI information is changed, the transmission device changes related information in step 507. Otherwise, the transmission device proceeds to step 508 without the change in ULI information. The transmission device determines in step 508 whether there is a change in LMI information. If the LMI information is changed, the transmission device changes related information in step 509 and completes NGH signaling information in step 510. If there is no change in LMI information, the transmission device completes information for an NGH signaling part in step 510 without the change in LMI information.

In the description of FIG. 5, the information may be changed in the order of LMI, OMI and ULI, or in other orders. An SGDD generator/transmitter 302 in FIG. 3 generates an SGDD with the structure illustrated in Tables 1 to 9, and transmits the SGDD to a mobile broadcast terminal 304 over a transmission network 303, which may be a broadcasting network for providing broadcast channels, or a communication network for providing interactive channels. The transmission device in FIG. 3 may be implemented with one or more servers. Therefore, the NGH signaling information generator 301 and the SGDD generator/transmitter 302 may be implemented with separate independent servers or a single server.

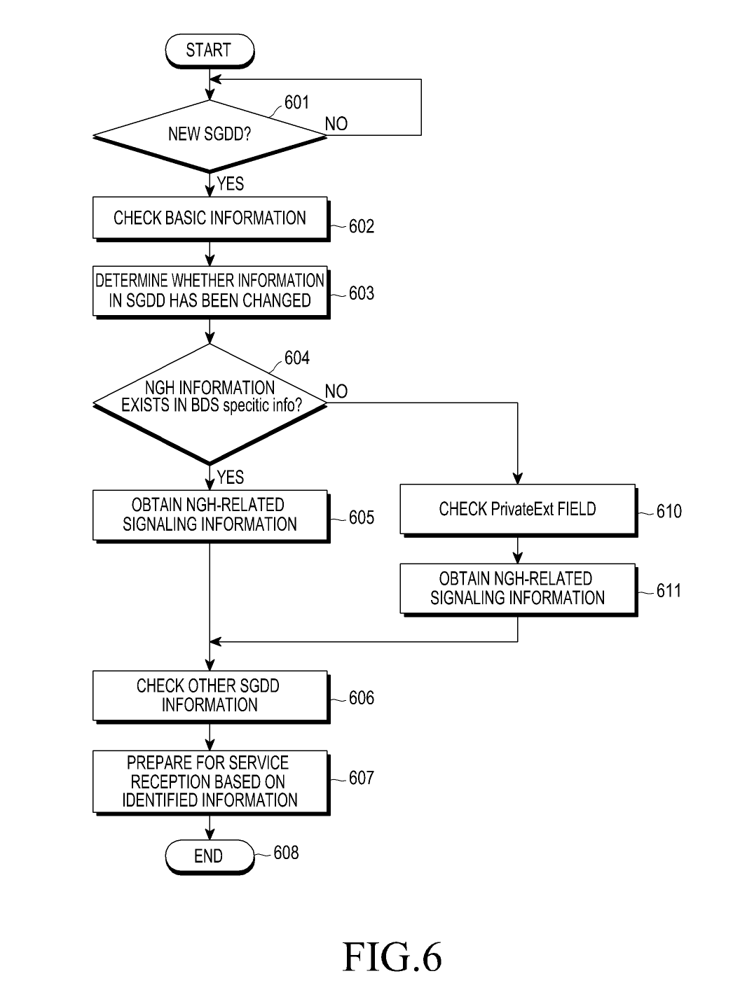

FIG. 4 illustrates a structure of a terminal as a reception device for receiving an SGDD including signaling information according to a first or second embodiment of the present invention. FIG. 6 illustrates a process of receiving the signaling information in the reception device of FIG. 4.

Referring to FIG. 4, a transmission network 404 is the same as the transmission network 303 in FIG. 3. An SGDD receiver 403 receives a transmitted SGDD over the transmission network 404, and transfers the received SGDD to an SGDD decomposer 402, which extracts elements and attributes from the received SGDD, and delivers the extracted elements and attributes to an SGDD analyzer 401. The SGDD analyzer 401 analyzes information in the SGDD delivered from the SGDD decomposer 402, and operations of the SGDD decomposer 402 and the SGDD analyzer 401 are shown in FIG. 6. The SGDD analyzer 401 and the SGDD decomposer 402 in FIG. 4 may be implemented as a controller in the terminal.

FIG. 6 illustrates an operation of a terminal on the assumption that the first and second embodiments disclosed in the present invention are used together. When only one of the first and second embodiments is available in operation, the terminal may extract the NGH signaling information from a related field of the SGDD and prepare for reception of a service.

Referring to FIG. 6, the terminal determines in step 601 whether a new SGDD has been received. Upon receiving a new SGDD, the terminal checks basic information in the SGDD in step 602 to determine whether it has received a proper SGDD. Upon receiving a proper SGDD, the terminal determines in step 603 whether information in the SGDD has been changed. In this process, as regards the NGH signaling information, the terminal may determine whether new information has been provided, based on version information of ULI, OMI and LMI disclosed in embodiments of the present invention.

In step 604, the terminal identifies the location of the NGH signaling information. In other words, the terminal determines whether the NGH signaling information is present in the ‘BDSSpecificEntryPointInfo’ field of the SGDD described in the first embodiment of the present invention, or whether the NGH signaling information is present in the ‘PrivateEXT’ field of the SGDD described in the second embodiment of the present invention. If the NGH signaling information is present in the ‘BDSSpecificEntryPointInfo’ field, the terminal obtains the NGH signaling information in step 605, and checks other SGDD information in step 606. However, it is determined in step 604 that the NGH signaling information is not present in the ‘BDSSpecificEntryPointInfo’ field, the terminal checks the ‘PrivateExt’ field in step 610, obtains the NGH signaling information in step 611, and checks other SGDD information in step 606. The order of obtaining the NGH signaling information and checking other SGDD information may be reversed. In step 607, the terminal receives information existing in a lower layer of the IP layer based on the identified information, receives a service guide, and prepares for receiving a mobile broadcast service transferred by NGH.

Tables 10 to 14 below show another structure of the ‘BDSSpecificEntryPointInfo’ field disclosed by an embodiment of the present invention. The devices and methods in FIGS. 3 to 6 may be applied even to the example of Tables 10 to 14. A detailed definition of the known terms used in Tables 10 to 14 is disclosed in OMA BCAST Service Guide 1.1.

Referring to Table 10, the “BDSSpecificEntrypointInfo” field is used to provide the ULI, LMI and OMI.

As another structure of the ULI, an “UpperLayerInformation” element in Table 10 includes a “Service” element as its lower element. The “Service” element provides information about services over the current channel, and includes a “Component” element as its lower element. The “Component” element provides information about the component, and includes a “ComponentLocation” element and a “ROHCInfo” element as its lower elements. The “ComponentLocation” element provides location information of the component, such as URL, IP address and port number, and the “ROHCInfo” element provides compression-related Robust Header Compression (ROHC) information.

As another structure of the LMI, a “LocalMultiplexInformation” element in Table 12 includes an “LLP_ID” element as its lower element. The “LLP ID” element is for uniquely identifying a Logical Layer Pipe (LLP) in the network. The “LLP_ID” element includes a “T_INT_LLPF” element, a “BS_LLPF” element, and a “PLP_ID” element as its lower elements. The “T_INT_LLPF” element represents a time between two consecutive LLP frames of the LLP. A receiver determines whether it can process a previous LLP frame during the time indicated by this parameter, and empties its buffer to process the next LLP frame. The “BS_LLPF” element indicates the maximum buffer size, i.e., the maximum size of the LLP frame, and the “PLP_ID” element is for uniquely identifying a Physical Layer Pipe (PLP).

As another structure of the OMI, an “OtherMultiplexInformation” element in Table 13 includes an “n_of_multiplexes” element as its lower element. The “n_of_multiplexes” element indicates the number of multiplexes undergoing signaling, and includes a “Frequency” element, a “Guard_INTERVAL” element, an “FFT-SIZE” element, a “PILOT_PATTERN” element, a “cell_id” element, a “frame_synch_offset” element and a “Component_Info” element as its lower elements.

Referring to Table 14, the “Frequency” element indicates a frequency at which a released multiplex is transmitted, and the “Guard_INTERVAL” element indicates a guard interval of the current superframe. The “FFT-SIZE” element indicates a Fast Fourier Transform (FFT) size, and the “PILOT_PATTERN” element indicates a pilot pattern used for OFDM symbols. The “cell_id” element uniquely indicates a cell in the network, the “frame synch offset” element indicates an offset between a physical layer frame transmitted in the current multiplex and a physical layer frame transmitted in an associated neighboring multiplex, and the “Component_Info” element provides information about services/service in the current and neighboring/adjacent multiplexes.

TABLE 10

| Name | Type | Category | Cardinality | Description | Data Type |
|---|---|---|---|---|---|
| BDSSpecificEntryPointInfo | E5 | NM/TM | 1 . . . N | The placeholder for the information that is required | complexType |
| | | | | in order to retrieve DVB-NGH Upper layer | deriving |
| | | | | signalling. | from |
| | | | | It has the following sub-elements | abstract type |
| | | | | UpperLayerInformation | of |
| | | | | LocalMultiplexInformation | BDSSpecific |
| | | | | OtherMultiplexInformation | EntryPointInfo |
| | | | | | element |
| UpperLayerInformation | E6 | NM/TM | 1 . . . N | UpplerLayerInformation provides the information | |
| | | | | of service/content mapping with NGH signalling. | |
| | | | | It has Service as sub-element. | |
| | | | | It has the following attributes. | |
| | | | | Version and Repetition Period. | |
| Version | A | NO/TO | 0 . . . 1 | It indicates the version of UpperLayerInformation | |
| Repetition | A | NO/TO | 0 . . . 1 | In indicates the repetition period of ULI. With these | |
| Period | | | | value terminal does not need to receive SGDD | |
| | | | | every time. | |
| Service | E7 | NM/TM | 1 . . . N | This field has the information of Services through | |
| | | | | the current channel. It has the information of | |
| | | | | components belongs to a specific service. | |
| | | | | It has Component as sub-element. | |
| | | | | It has an attribute of ServiceName | |
| ServiceName | A | NM/TM | 1 | Name of Service. | anyURI |
| Component | E8 | NM/TM | 1 . . . N | This field has the information of component. It has | |
| | | | | the following sub-elements. | |
| | | | | ComponentLocation | |
| | | | | ROHCInfo | |
| Component | E9 | NM/TM | 1 . . . N | Location of Component. It will have the value of | |
| Location | | | | UPL or IP address and Port number | |
| | | | | It has the following sub-element, | |
| | | | | ComponentLocationURL | |
| | | | | ComponentLocationAddress | |
| | | | | PLP_ID | |
| | | | | LLP_ID | |

TABLE 11

| | | | | | |
|---|---|---|---|---|---|
| ComponentLocationURL | E10 | NM/TM | 0 . . . 1 | Location of Component | anyURI |
| ComponentLocationAddress | E10 | NM/TM | 0 . . . 1 | IP address and Port Number of Component | |
| | | | | It has the following sub-elements. | |
| | | | | IP | |
| | | | | PortNumber | |
| IP | E11 | NM/TM | 1 | IP address of Component | String |
| PortNumber | E11 | NM/TM | 1 | Port Number of Component | unsignedInt |
| PLP_ID | E10 | NM/TM | 1 | This 8-bit field identifies uniquely the physical | uimsbf |
| | | | | layer pipe through which the corresponding | |
| | | | | component is delivered. | |
| LLP_ID | E10 | NM/TM | 1 | This 16-bit identifier identifies uniquely one | uimsbf |
| | | | | logical layer pipe within network (identified with | |
| | | | | network_id). | |
| ROHCInfo | E9 | NO/TO | 0 . . . 1 | When ROHC is used, this field provides the | |
| | | | | information of ROHC. | |
| | | | | Each IP data streams are compressed by RoHC- | |
| | | | | U+ mode, and some basic information is needed | |
| | | | | to decompress the RoHC stream. ROHCinfo | |
| | | | | will give the compressed stream id for each IP | |
| | | | | stream, what kind of profile it is using, and the | |
| | | | | static chain byte to initialize the decompression. | |
| context_ID | E10 | NO/TO | 0 . . . 1 | This 8-bit or 16-bit field indicates the context id | uimsbf |
| | | | | of the compressed IP stream. The RoHC uses two | |
| | | | | kinds of CID (context id)'s - one is small and the | |
| | | | | other is large. The small CID is one octet from 1 | |
| | | | | to 15, and the large CID is one or two octets from | |
| | | | | 1 to 16383. The size of context id is determined | |
| | | | | from the rule below. | |
| | | | | Start with ‘1110’: small CID, context | |
| | | | | size is 1 octet, CID is remaining 4 bits | |
| | | | | (range: 1~15) | |
| | | | | Start with ‘0’; large CID, context size | |
| | | | | is 1 octet, CID is remaining 7 bits | |
| | | | | (range: 1~127) | |
| | | | | Start with ‘10’; large CID, context | |
| | | | | size is 2 octet, CID is remaining 14 | |
| | | | | bits (range: 1~16383) | |
| Context_Profile | E10 | NO/TO | 0 . . . 1 | This 8-bit field indicates the context profile of the | uimsbf |
| | | | | compressed IP stream. It notifies the range of | |
| | | | | protocols that RoHC uses to compress the stream. | |
| Static_chain_byte | E10 | NO/TO | 0 . . . N | This byte sequence is the static information of the | bslbf |
| | | | | compressed IP stream. This field is used to | |
| | | | | initialize the compressed IP stream by RoHC, and | |
| | | | | the size and structure of this byte sequence are | |
| | | | | dependent upon the context profile. | |

TABLE 12

| | | | | | |
|---|---|---|---|---|---|
| LocalMultiplexInfomation | E6 | NM/TM | 1 . . . N | LocalMultiplexInformation (LMI) consists of the | |
| | | | | mapping of LLP_IDs with the PLPs within the | |
| | | | | local multiplex. In addition, t | |
| | | | | LocalMultiplexInformation (LMI) provides | |
| | | | | information about the buffer model of the | |
| | | | | associated LLP. | |
| | | | | It has LLP_ID as sub-element. | |
| | | | | It has the following attributes. | |
| | | | | Version and Repetition Period. | |
| Version | A | NO/TO | 0 . . . 1 | It indicates the version of | |
| | | | | LocalMultiplexInfomation | |
| Repetition | A | NO/TO | 0 . . . 1 | In indicates the repetition period of LMI. With | |
| Period | | | | these value terminal does not need to receive | |
| | | | | SGDD every time. | |
| LLP_ID | E7 | NM/TM | 1 . . . N | This 16-bit identifier identifies uniquely one | uimsbf |
| | | | | logical layer pipe within network (identified with | |
| | | | | network_id). | |
| | | | | It has the following sub-elements. | |
| | | | | T_INT_LLPF | |
| | | | | BS_LLPF | |
| | | | | PLP_ID | |
| T_INT_LLPF | E8 | NM/TM | 1 | This 16-bit field indicates the time (e.g. in | uimsbf |
| | | | | milliseconds or in OFDM symbols) between two | |
| | | | | consecutive LLP frames of an LLP. Based on this | |
| | | | | parameter receiver may calculate whether it is | |
| | | | | able to process the previous LLP frame during | |
| | | | | this time period and free the buffer space for the | |
| | | | | processing of the next LLP frame | |
| BS_LLPF | E8 | NM/TM | 1 | This 24-bit field indicates the maximum buffer | uimsbf |
| | | | | size as OFDM cells i.e. the maximum size of the | |
| | | | | LLP frame. | |
| PLP_ID | E8 | NM/TM | 1 . . . N | This 8-bit field identifies uniquely the physical | uimsbf |
| | | | | layer pipe, which belongs to LLP having LLP-ID | |

TABLE 13

| | | | | | |
|---|---|---|---|---|---|
| OtherMultiplexInformation | E6 | NM/TM | 1 . . . N | The Other Multiplex Information (OMI) lists | |
| | | | | those components carried within the local | |
| | | | | multiplex, which are also available within the | |
| | | | | other multiplexes located within the signals | |
| | | | | adjacent to the currently received signal. | |
| | | | | It has n_of_multiplexers as a sub element. | |
| Version | A | NO/TO | 0 . . . 1 | It indicates the version of | |
| | | | | OtherMultiplexInformation. | |
| Repetition | A | NO/TO | 0 . . . 1 | In indicates the repetition period of OMI. With | |
| Period | | | | these value terminal does not need to receive | |
| | | | | SGDD every time. | |
| networkID | A | NM/TM | 0 . . . 1 | When the IP Platform ID is not globally unique, | unsignedShort |
| | | | | identifies the DVB Network scoping the IP | |
| | | | | Platform ID value. | |
| n_of_multiplexes | E7 | NM/TM | 1 . . . N | This field indicates the number of the multiplexes | |
| | | | | signaled within the loop which follows after this | |
| | | | | field. | |
| | | | | It has the following sub-elements. | |
| | | | | Frequency | |
| | | | | Guard_INTERVAL | |
| | | | | FFT-SIZE | |
| | | | | PILOT_PATTERN | |
| | | | | cell_id | |
| | | | | frame_synch_offset | |
| | | | | Component_Info | |

TABLE 14

| | | | | | |
|---|---|---|---|---|---|
| frequency | E8 | NM/TM | 0 . . . 1 | This field indicates the frequency in which the | unsignedInt |
| | | | | associated multiplex is transmitted [Defined in | |
| | | | | EN 300 468] | |
| GUARD_INTERVAL | E8 | NM/TM | 0 . . . 1 | This field indicates the guard interval of the | unsignedInt |
| | | | | current super-frame according to EN 302 755. | |
| FFT_SIZE | E8 | NM/TM | 0 . . . 1 | This field indicates the FFT size according to EN | unsignedInt |
| | | | | 302 755 | |
| PILOT_PATTERN | E8 | NM/TM | 0 . . . 1 | This field indicates the scattered pilot pattern used | unsignedInt |
| | | | | for the data OFDM symbols according to EN | |
| | | | | 302 755 | |
| cell_id | E8 | NM/TM | 0 . . . 1 | This field identifies uniquely the cell within | unsignedInt |
| | | | | network. [Defined in EN 300 468] | |
| frame_synch_offset | E8 | NM/TM | 0 . . . 1 | This field indicates the offset between the physical | unsignedInt |
| | | | | layer frame transmitted within the current | |
| | | | | multiplex vs. the physical layer frame transmitted | |
| | | | | within the associated neighbouring multiplex. | |
| Component_Info | E8 | NM/TM | 0 . . . N | This element provides the information of | |
| | | | | services/service components within current and | |
| | | | | neighbouring/adjacent multiplexes. | |
| | | | | It has the following sub-elements. | |
| | | | | Component_ID | |
| COMPONENT_ID | E9 | | 1 | A ‘short_id’ or index which is used temporarily | uimsbf |
| | | | | for the identification of services/service | |
| | | | | components within current and | |
| | | | | neighbouring/adjacent multiplexes. | |
| | | | | COMPONENT_ID is unique within each local | |
| | | | | OMI_section and hence it can be re-used by each | |
| | | | | multiplex for it's signaling of current and adjacent | |
| | | | | services. | |
| PLP_ID | E9 | NM/TM | 1 | This 8-bit field identifies uniquely the physical | uimsbf |
| | | | | layer pipe, which belongs to LLP having LLP-ID | |
| LLP_ID | E9 | NM/TM | 1 | This 16-bit identifier identifies uniquely one | uimsbf |
| | | | | logical layer pipe within network (identified with | |
| | | | | network_id). | |

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for receiving a broadcast service in a digital broadcasting system, comprising:
receiving a Service Guide Delivery Descriptor (SGDD) over a network, the SGDD providing signaling information related to reception of the broadcast service;
extracting the signaling information from the received SGDD, and analyzing the extracted signaling information;
receiving a service guide for reception of the broadcast service based on the analyzed signaling information; and
receiving the broadcast service based on the received service guide.

2. The method of claim 1, wherein the signaling information is extracted from a specific field of the SGDD.

3. The method of claim 2, wherein the specific field of the SGDD is at least one of a ‘BDSSpecificEntrypointInfo’ field associated with characteristics of the digital broadcasting system and used for reception of the service guide and a ‘PrivateExt’ field associated with a service provider and used to provide additional data, among elements of the SGDD.

4. The method of claim 1, wherein the signaling information includes at least one of Other Multiplex Information (OMI) including network identification information and frequency information of the digital broadcasting system, Local Multiplex Information (LMI) including link information to a Logical Link Pipe (LLP) and a Physical Link Pipe (PLP), and Upper Layer Information (ULI) including service guide-related information.

5. The method of claim 4, wherein the ULI includes at least one of compression-related Robust Header Compression (ROHC) information, identification information for the LLP, and identification information for the PLP.

6. The method of claim 1, wherein the signaling information is in an upper layer of an Internet Protocol (IP) layer, and is used to receive information in a lower layer of the IP layer.

7. An apparatus for receiving a broadcast service in a digital broadcasting system, comprising:
a receiver for receiving, over a network, the broadcast service and signaling information related to reception of the broadcast service; and
a controller for receiving a Service Guide Delivery Descriptor (SGDD) providing the signaling information, extracting the signaling information from the received SGDD, analyzing the extracted signaling information, receiving a service guide for reception of the broadcast service based on the analyzed signaling information, and receiving the broadcast service based on the received service guide.

8. The apparatus of claim 7, wherein the signaling information is extracted from a specific field of the SGDD.

9. The apparatus of claim 8, wherein the specific field of the SGDD is at least one of a ‘BDSSpecificEntrypointInfo’ field associated with characteristics of the digital broadcasting system and used for reception of the service guide and a ‘PrivateExt’ field associated with a service provider and used to provide additional data, among elements of the SGDD.

10. The apparatus of claim 7, wherein the signaling information includes at least one of Other Multiplex Information (OMI) including network identification information and frequency information of the digital broadcasting system, Local Multiplex Information (LMI) including link information to a Logical Link Pipe (LLP) and a Physical Link Pipe (PLP), and Upper Layer Information (ULI) including service guide-related information.

11. The apparatus of claim 10, wherein the ULI includes at least one of compression-related Robust Header Compression (ROHC) information, identification information for the LLP, and identification information for the PLP.

12. The apparatus of claim 7, wherein the signaling information is in an upper layer of an Internet Protocol (IP) layer, and is used to receive information in a lower layer of the IP layer.

13. A method for providing a broadcast service in a digital broadcasting system, comprising:
transmitting a Service Guide Delivery Descriptor (SGDD) over a network, the SGDD including signaling information related to the broadcast service;
transmitting a service guide, for reception of the broadcast service, that a terminal may receive based on the signaling information; and
transmitting the broadcast service related to the service guide.

14. The method of claim 13, wherein the signaling information is provided in a specific field of the SGDD.

15. The method of claim 14, wherein the specific field of the SGDD is at least one of a ‘BDSSpecificEntrypointInfo’ field associated with characteristics of the digital broadcasting system and used for reception of the service guide and a ‘PrivateExe’ field associated with a service provider and used to provide additional data, among elements of the SGDD.

16. The method of claim 13, wherein the signaling information includes at least one of Other Multiplex Information (OMI) including network identification information and frequency information of the digital broadcasting system, Local Multiplex Information (LMI) including link information to a Logical Link Pipe (LLP) and a Physical Link Pipe (PLP), and Upper Layer Information (ULI) including service guide-related information.

17. The method of claim 16, wherein the ULI includes at least one of compression-related Robust Header Compression (ROHC) information, identification information for the LLP, and identification information for the PLP.

18. The method of claim 13, wherein the signaling information is in an upper layer of an Internet Protocol (IP) layer, and includes information used to provide information in a lower layer of the IP layer to the terminal.

19. A system for providing a broadcast service in a digital broadcasting system, comprising:
means for providing a Service Guide Delivery Descriptor (SGDD) over a network, the SGDD including signaling information related to the broadcast service;
means for providing a service guide for reception of the broadcast service that a terminal may receive based on the signaling information; and
means for providing the broadcast service related to the service guide.

20. The system of claim 19, wherein the signaling information is provided in a specific field of the SGDD.

21. The system of claim 20, wherein the specific field of the SGDD is at least one of a ‘BDSSpecificEntrypointInfo’ field associated with characteristics of the digital broadcasting system and used for reception of the service guide and a ‘PrivateExe’ field associated with a service provider and used to provide additional data, among elements of the SGDD.

22. The system of claim 19, wherein the signaling information includes at least one of Other Multiplex Information (OMI) including network identification information and frequency information of the digital broadcasting system, Local Multiplex Information (LMI) including link information to a Logical Link Pipe (LLP) and a Physical Link Pipe (PLP), and Upper Layer Information (ULI) including service guide-related information.

23. The system of claim 22, wherein the ULI includes at least one of compression-related Robust Header Compression (ROHC) information, identification information for the LLP, and identification information for the PLP.

24. The system of claim 19, wherein the signaling information is in an upper layer of an Internet Protocol (IP) layer, and includes information used to provide information in a lower layer of the IP layer to the terminal.
